(19) United States
(12) Patent Application Publication
(10) Pub. No.: US 2025/0298662 A1
(43) Pub. Date: Sep. 25, 2025

(54) MULTI-PHASED SCHEDULER

(71) Applicant: ServiceNow, Inc., Santa Clara, CA (US)

(72) Inventors: Yerjan Khurmyetbyek, Bellevue, WA (US); Sainadh Ainala, Renton, WA (US)

(21) Appl. No.: 18/615,256

(22) Filed: Mar. 25, 2024

(51) Int. Cl. G06F 9/48

(52) U.S. Cl. CPC G06F 9/4887

(57) ABSTRACT

Various implementations disclosed herein include determining a timeframe for a data operation, splitting the data operation into phases, determining which phases can be concurrently performed with a phase of a different operation, and scheduling the operations based on both the timeframe and the determined concurrency.

### TECHNICAL FIELD

The present disclosure relates to scheduling one or more phases of a data operation to occur during at least partially overlapping timeframes with one or more phases another data operation.

### BACKGROUND

Data operations (e.g., patch updates, server migrations, data clone, lookup, restore, etc.) for one or more clients need to be scheduled and reserved in advance by reserving a timeframe (e.g., a calendar window) before the operations can be executed. However, when one operation is scheduled, other operations cannot be completed. As the number of operations to be completed increases, there is a corresponding reduction in timeframe availability to perform these data operations for each client.

### SUMMARY

One aspect of the disclosure includes a method for obtaining a timeframe value that indicates a corresponding phase of a first data operation. The method may further include determining, based on the timeframe value, an overlap between the corresponding phase of the first data operation and a phase of a second data operation. The method may further include causing the first and second data operations to be performed according to the timeframe value and the overlap.

Implementations of the disclosure may include one or more of the following features. The method may include scheduling the corresponding phase of the first data operation and the phase of the second data operation to be performed within a predetermined window. The method may additionally indicate that determining the overlap is based, at least in part, on identifying a relationship indicating the overlap and a time gap between the corresponding phase of the first data operation and the phase of the second data operation. The method may further include identifying a conflict associated with the corresponding phase of the first data operation, wherein determining the overlap is based, at least in part, on the conflict identified. The method may further include performing an application programming interface (API) to identify the timeframe value in which the first and second data operations are to be performed and proposing the timeframe value identified to another API. The method may further include determining, based on the timeline value, a gap between a third data operation phase and one of the corresponding phase of the first data operation or the phase of the second data operation and performing, as a result of the determination, the third data operation phase at a timing according to the gap. The method may further include performing an application programming interface (API) to remove one or more secondary phases from a schedule and scheduling the first and second data operations to be performed according to the timeframe value, the overlap, and a removal of the one or more secondary phases.

Another aspect of the disclosure includes a system comprises one or more processors and a memory including computer-executable instructions. The one or more processors, when executing the computer-executable instructions, may cause the system to obtain a timeframe value that indicates a corresponding phase of a first data operation. The one or more processors may further cause the system to determine, based on the timeframe value, an overlap between the corresponding phase of the first data operation and a phase of a second data operation. The one or more processors may further cause the system to cause the first and second data operations to be performed according to the timeframe value and the overlap.

Implementations of the disclosure may additionally include one or more of the following features. The one or more processors may further cause the system to schedule the corresponding phase of the first data operation and the phase of the second data operation to be performed within a predetermined window. The one or more processors may further cause the system to indicate that the overlap is determined based on a relationship between the corresponding phase of the first data operation and the phase of the second data operation. The one or more processors may further cause the system to determine the overlap based, at least in part, on identifying a conflict associated with the corresponding phase of the first data operation. The one or more processors may further cause the system to indicate the conflict is at least one of a blackout period, an automation restriction, a custom hour requirement, a throttle limit, or a stagger limit. The one or more processors may further cause the system to determine a gap timing between a third data operation phase and one of the at least one of the corresponding phase of the first data operation and the phase of the second data operation and cause the third data operation phase to be performed at a timing based, at least in part, on the determined gap. The one or more processors may further cause the system to indicate that a schedule indicating the timeframe value is stored in the memory.

Another aspect of the disclosure includes a non-transitory computer-readable storage medium having stored thereon executable instructions that are executable by one or more processors of a computer system. The computer-readable storage medium may include instructions that cause the computer system to obtain a timeframe value that indicates a corresponding phase of a first data operation. The computer-readable storage medium may further include instructions that cause the computer system to determine, based on the timeframe value, an overlap between the corresponding phase of the first data operation and a phase of a second data operation. The computer-readable storage medium may further include instructions that cause the computer system to cause the first and second data operations to be performed according to the timeframe value and the overlap.

Implementations of the disclosure may additionally include one or more of the following features. The computer-readable storage medium may further include instructions that cause the computer system to schedule the corresponding phase of the first data operation and the phase of the second data operation to be performed within a predetermined window. The computer-readable storage medium may further include instructions that cause the computer system to identify an overlap compatibility of one or more phases of the first data operation and one or more phases of the second data operation. The computer-readable storage medium may further include instructions that cause the computer system to identify a conflict associated with the corresponding phase of the first data operation. The computer-readable storage medium may further include instructions that cause the computer system to perform an application programming interface (API) to schedule a time window for the first and second data operations to be performed based, at least in part, on the determined overlap and store the scheduled time window into memory. The computer-readable storage medium may further include instructions that cause the computer system to determine a gap timing between a third data operation phase and one of the at least one of the corresponding phase of the first data operation and the phase of the second data operation and cause the third data operation phase to be performed at a timing based, at least in part, on the determined gap.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

Various embodiments in accordance with the present disclosure will be described with reference to the drawings, in which:

FIG. 1 illustrates a multi-phased scheduler system, in accordance with at least one embodiment;

FIG. 2A-2B illustrates a visual representation of multi-phased scheduling, in accordance with at least one embodiment;

FIG. 3 illustrates a visual representation of a time window determination for multi-phased scheduling, in accordance with at least one embodiment;

FIGS. 4A-4D illustrates a visual representation of relationships between phases of a data operation, in accordance with at least one embodiment;

FIG. 5 illustrates a visual representation of a proposal function used with a multi-phased scheduler system, in accordance with at least one embodiment;

FIG. 6 illustrates a flowchart describing multi-phased scheduling process, in accordance with at least one embodiment;

FIG. 7 illustrates a flowchart describing a proposal process used with a multi-phased scheduling process, in accordance with at least one embodiment;

FIGS. 8A-8B illustrates additional detail of the proposal process used in a multi-phased scheduling system, in accordance with at least one embodiment;

FIG. 9 illustrates a flowchart describing a scheduling process used in a multi-phased scheduling system, in accordance with at least one embodiment;

FIGS. 10A-10B illustrates additional detail of the scheduling process used in a multi-phased scheduling system, in accordance with at least one embodiment; and

FIG. 11 illustrates a system in which various embodiments can be implemented.

### DETAILED DESCRIPTION

In preceding and following descriptions, various techniques are described. For purposes of explanation, specific configurations and details are set forth in order to provide a thorough understanding of possible ways of implementing techniques. However, it will also be apparent that techniques described below may be practiced in different configurations without specific details. Furthermore, well-known features may be omitted or simplified to avoid obscuring techniques being described.

The scheduling framework is a central intelligence layer where automated data operations (also referred to herein as “automations”) are scheduled and planned. For example, a client user would establish an automation that installs regular operating system (OS) patching updates automatically on a scheduled monthly basis according to some preset timing, availability, or other constraints. The scheduling framework would allocate and reserve a specific day and timeframe for that one OS update automation, preventing another automation from taking place at the same time.

Over time, the number of clients and the number of data operations increases, but calendar availability to schedule the operations does not. Some automations, however, have certain phases (also referred to herein as “sub-operations”) that are capable of overlap with another phase of another operation. For example, a phase of a data restoration automation for one client and a phase of an enable/disable automation for another client may be capable of occurring at the same time because accessing resources for one automation would not conflict with accessing resources for the other automation. By performing these phases at the same time, more total automations can be established in the master schedule.

Various implementations disclosed herein include determining a timeframe for a data operation, splitting the data operation into phases, determining which phases can be concurrently performed with a phase of a different operation, and scheduling the operations based on both the timeframe and the determined concurrency. In an embodiment, a given data operation is split into multiple phases (e.g., a preparation phase, a cutover phase, and a post cutover phase.) Because different phases require different conditions (e.g., file dependencies, blackout times, etc.) or computing resources (e.g., servers, disks, services, networking resources, physical or abstract component instances, etc.), a phase of one operation can be performed concurrently with another phase of a different operation.

In at least one embodiment, the data operation to be scheduled is first input to a propose application programming interface (API), which identifies the phases of the data operation and defines a time window in which the phases can be performed. Then, this is input to a schedule API that identifies which phases of one operation can be concurrently performed with another phase of another operation based on the type of operations being performed and resources needed and optimally schedules the phases from multiple operations. Because some of these phases of data operations are performed at the same time, more operations can be scheduled overall in a given timeframe (also called “reservation window”).

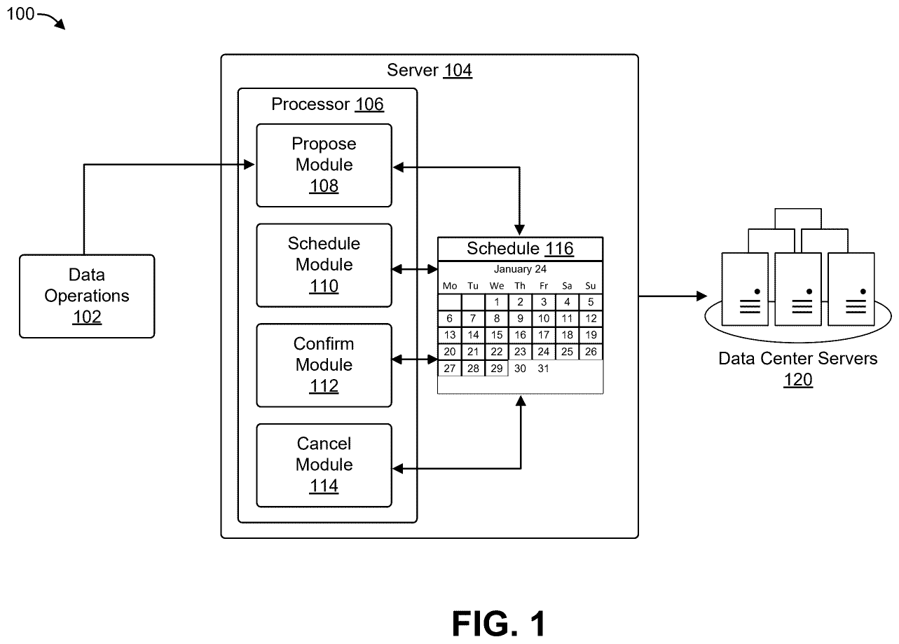

FIG. 1 illustrates a multi-phased scheduler system (100), in accordance with at least one embodiment. In at least one embodiment, system 100 comprises one or more servers 104 having one or more processors 106 that schedule one or more data operations 102 to occur at one or more data center servers 120. In at least one embodiment, processor 106 also includes a schedule 116 (e.g., a memory storing the set schedule of data operations) indicates when the data operations 102 should occur. In at least one embodiment, system 100 performs a multi-phased scheduling method comprising obtaining a timeframe value that indicates a corresponding phase of a first data operation; determining, based on the timeframe value, an overlap between the corresponding phase of the first data operation and a phase of a second data operation; and causing the first and second data operations to be performed according to the timeframe value and the overlap.

In at least one embodiment, data operations 102 are input to server 104. In at least one embodiment, data operations 102 are automated operations preset to occur at some regular frequency during an established timeframe. In at least one embodiment, data operations 102 include data cloning, move, monthly server patching, data restore, backup, service start/stop, update configuration, enable/disable features, upscale/downscale, DBDrain, rack drain, app server drain, Delete F5 VIP, F5 To ADCv2 Migration, Manual Change, AIS Node Drain, AIS In-Place Upsize, IAElasticNodeDrain, KEK Rotation-TSE, AIS Partition Drain, AutomationAsAService, IAStandaloneElasticNodeDrain, Read Replica Provision, and/or other types of automations preset by a user.

In at least one embodiment, a processor 106 in a server 104 receives data operations 102 to be scheduled. In at least one embodiment, the processor 106 is a graphics processing unit (GPU), general-purpose GPU (GPGPU), parallel processing unit (PPU), central processing unit (CPU)), a data processing unit (DPU), a part of a system on chip (SoC), or combination thereof. In at least one embodiment, server 104 is one of data center servers 120. In at least one embodiment, server 104 is a remotely located server or a separate computing device connected to the data center servers 102.

In at least one embodiment, processor 106 obtains a timeframe value of a data operations 102 and determines what phases or sub-operations comprise each of the data operations 102. In at least one embodiment, processor 106 determines whether a phase of a first data operation can overlap and be performed concurrently with a phase of a second data operation. In at least one embodiment, processor 106 identifies existing conflicts from a profile, which contains information about relevant conflicts for a given phase and/or automation.

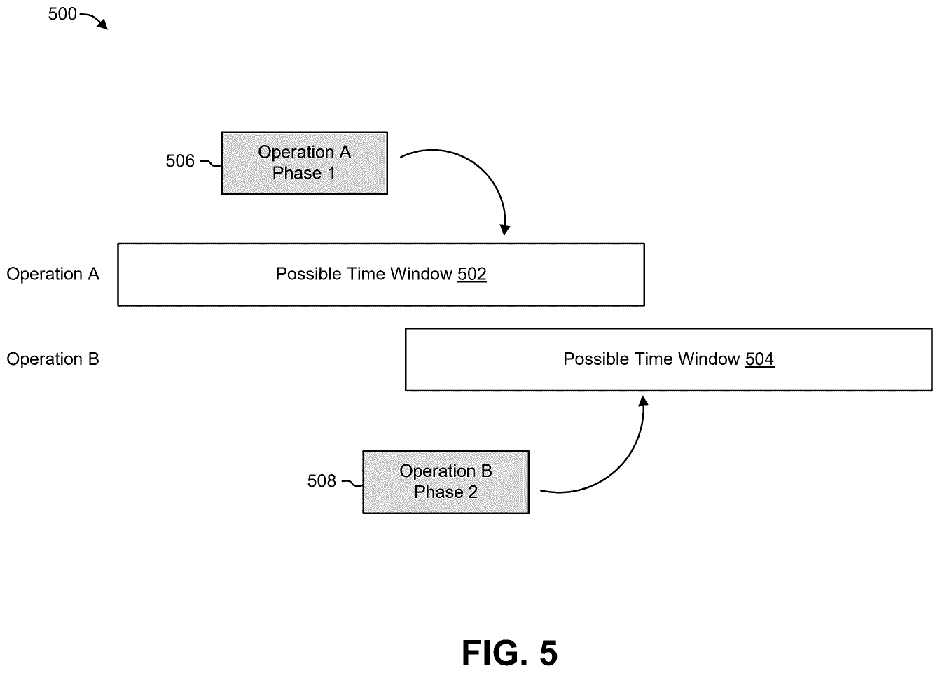

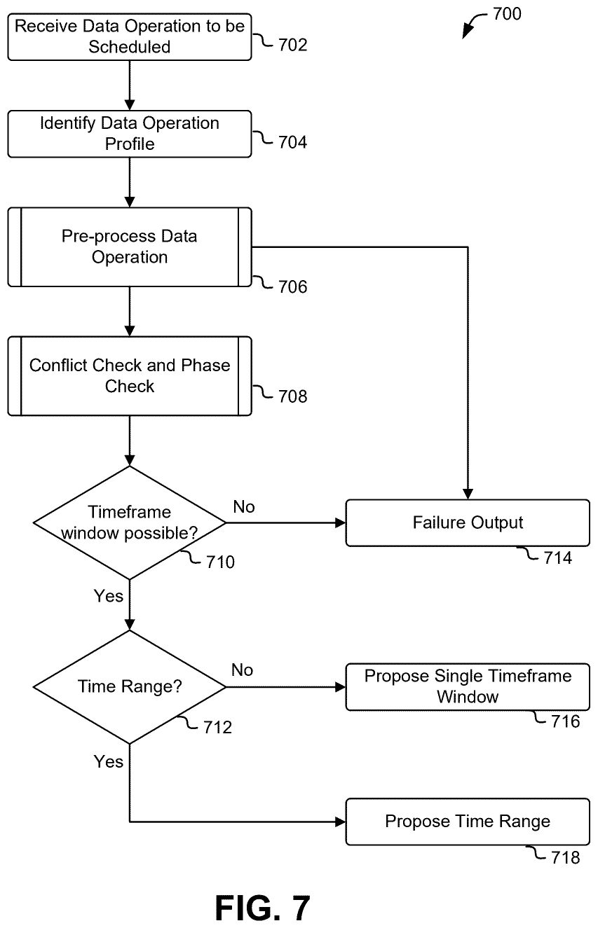

In at least one embodiment, processor 106 has a propose module 108 that performs a propose API. In at least one embodiment, propose module 108 receives data operations 102 and identifies which phases comprise each data operation. Then, in at least one embodiment, propose module 108 performs the propose API to receive scheduling information from schedule 116 that indicates what timeframes are available for use and proposes a time window or a time range in which each of the identified phases can be scheduled (further explained with reference to FIGS. 5 and 7.)

An exemplary simple implementation of the propose API being performed by propose module 108 is as follows:
var request=MPS.builder ( )
   .setProfileSystemId (<system_id>)
   .setInputs (<list of system_ids>)
   .setSearchStartTime (<DateTime>)
   .setSearchEndTime (<DateTime);
var response=MPS.propose (request);
   where MPS refers to the multi-phased scheduler framework used by the multi-phased scheduler system described herein.

Another exemplary implementation of the propose API being performed by propose module 110 is as follows:
var request=MPS.builder ( )
   .setProfileSystemId (<system_id>)
   .setInputs (<list of system_ids>)
   .setSearchStartTime (<DateTime>)
   .setSearchEndTime (<DateTime);
   .setDatacenterSystemIdForTimeZone (<system_id>)
   .addPhase (MPS.PhaseBuilder( )
      .setPhaseSystemId(<system_id>)
      .setInputCis(<list of system_ids>)
      .setStartTime(<DateTime>)
      .setDuration(<int duration>));
var response=MPS.propose (request);

An exemplary pseudocode implementation of the propose API being performed by propose module 110 is as follows:
function placePhase (requestObject, phaseIndex, heuristicStart) {
   1. find first window for current phase (added pseudo code below)
   2. find heuristic start for next phase
   3. placePhase (i+1, heuristicStart)->shiftRequest
   4. evaluate shift request from next phase
      a. if shiftRequest>tolerableGap
         then new_start_point=start_point+shift_request
         go to step 1
      b. successful placement
   5. optimize tolerableGap—Minimize total duration between phases closer by getting rid of tolerableGaps (if possible)
where requestObject represents conflicting rules, phase relations, conflict free available regions, phaseIndex indicates a phase to be placed, and searchStartTime represents original search start time to find available regions.
getFirstWindow (startTime, duration, availableRegions)
   1. iterate through available regions
   2. for each available region
      if (availableRegion.endTime<startTime) continue.
      if (startTime<availableRegion.startTimestart) start=availabeRegion.startTime;
      end=start+duration;
      if (end>availableRegion.endTime) continue
   3. return new TimeRange (start, end);
where startTime represents a search start time, duration indicates a total duration of a phase to be scheduled, and availableRegions is a list of available time windows in which a phase can be placed.

In at least one embodiment, the proposed time windows or the proposed time range is based on a whether a phase of a data operation has one or more conflicts (e.g., preset constraints identifying when an operation cannot occur). In at least one embodiment, these conflicts include client requirements (e.g., “no server updates during business hours”) and/or internal company operational requirements (e.g., “no operations during blackout periods”). In at least one embodiment, conflicts include blackout periods (e.g., times when physical network connections at the data center is shut down), automation restriction (e.g., scheduled days or times in which no operations are to be performed), custom hour restriction (e.g., only perform or do not perform automations during business hours or weekends), additional phase conflicts (e.g., operational conflicts specific to the phase being checked), throttle limits (e.g., a restrictive cap on the amount of automations or data operations to be performed at one time), stagger limits (e.g., a an intentional minor delay in performing a phase so as to not overwhelm a system by performing a group of phases all at the exact same time), other scheduled operations (e.g., another scheduled operation that cannot overlap with the current one), and/or other conflicts preset by a user of the system.

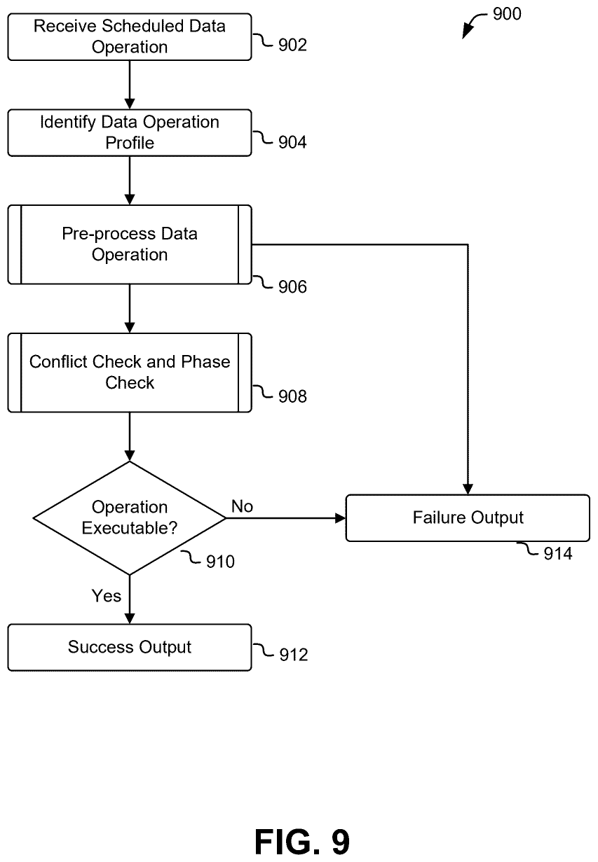

In at least one embodiment, processor 106 has schedule module 110 that performs a schedule API. In at least one embodiment, schedule module 110 receives a proposed time window or a time range from propose module 108 and schedule information from schedule 116. Then, in at least one embodiment, schedule module 110 performs the schedule API to register the phases of the data operations in the schedule 116 to be performed at predetermined date and time (further explained with reference to FIG. 9.)

An exemplary simple implementation of the schedule API being performed by schedule module 110 is as follows:
var proposeResponse=MPS.propose (request);
var reservation=MPS.schedule(proposeResponse);
   which utilizes a response from the propose API described above as the direct input to set a reserved time window in the schedule.

Another exemplary implementation of the schedule API being performed by scheduled module 110 is as follows:
var request=MPS.builder ( )
   .setProfileSystemId(<system_id>)
   .setInputs(<list of system_ids>)
   .addPhase (//phase 1
      MPS.phaseBuilder ( )
         .setPhaseId(<phase_system_id>)
         .setInputs (<list of system_ids>)
         .setStartTime (<DateTime>)
         .setEndTime (<DateTime>)
   )
   .addPhase (//phase N
      MPS.phaseBuilder ( )
         .setPhaseId(<phase_system_id>)
         .setInputs (<list of system_ids>)
         .setStartTime (<DateTime>)
         .setEndTime (<DateTime>)
   )
var response=MPS.schedule (request);

In at least one embodiment, processor 106 has confirm module 112 that performs a confirm API. In at least one embodiment, confirm module 112 receives data operations 102 or phase information of the data operations 102 and performs a confirm API that identifies whether any conflicts exist for an operation or phase for a given timeframe obtained from scheduled 116.

An exemplary implementation of the confirm API being performed by confirm module 112 is as follows:
var response=MPS.builder( )
   .setProfileSystemId(<system_id>)
   .setInputs(<list of system_ids>)
   .setSearchStartTime(<DateTime>)
   .setSearchEndTime (<DateTime>);
var response=MPS.confirm(request);

In at least one embodiment, processor 106 has cancel module 114 that performs a cancel/release API. In at least one embodiment, cancel module 112 receives scheduled operations from schedule 116 and performs a cancel/release API to cancel an existing scheduled operation and release that reserved timeframe for use by another phase or data operation.

An exemplary implementation of the cancel/release API being performed by cancel module 114 is as follows:
var response=MPS.builder ( )
   .setProfileSystemId(<system_id>)
   .setTicketNumber(<ticket_number>)
   .cancel( )
var response=MPS.builder( )
   .setProfileSystemId(<system_id>)
   .setTicketNumber(<ticket_number>)
   .release( );

In at least one embodiment, when a timeframe for scheduled data operation or phase has been reached according to schedule 116, the data operation 102 is performed at data center 120.

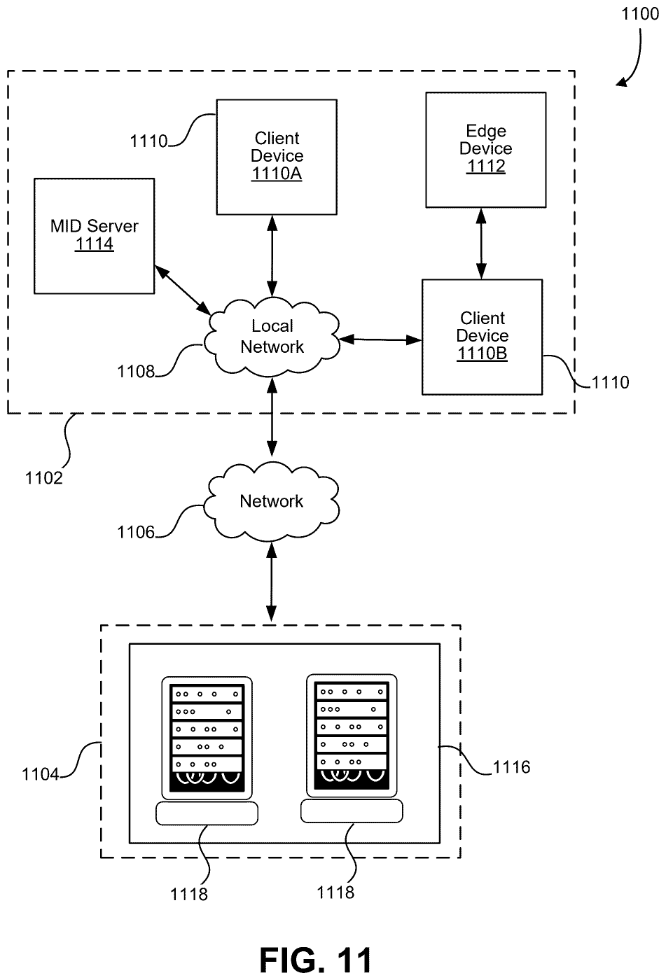

In an embodiment, some or all of the processes of system 100 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process of system 100 may be performed by any suitable system, such as the computing device 1100 of FIG. 11.

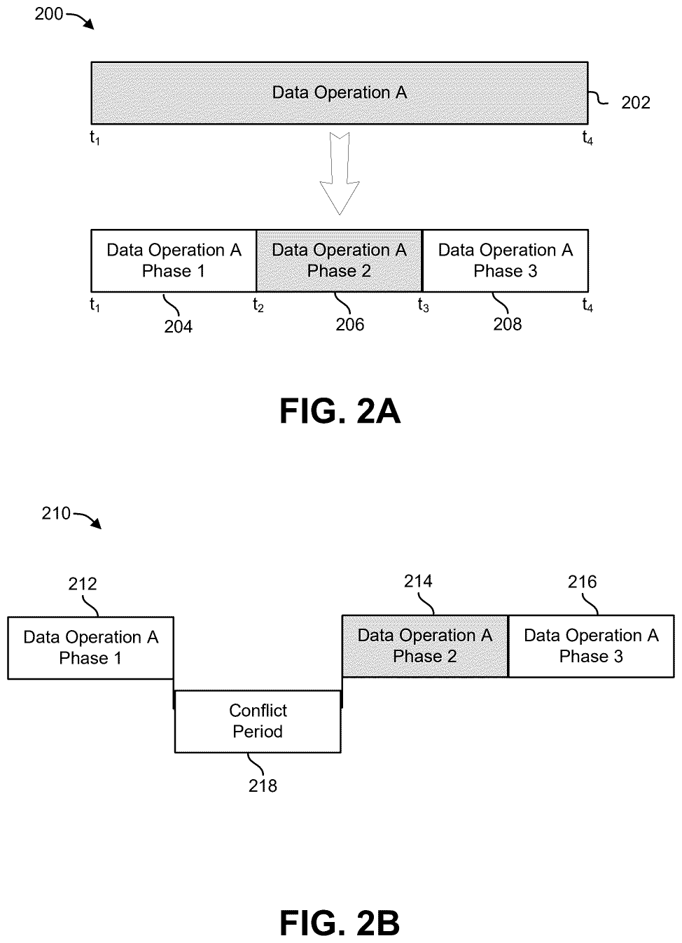

FIG. 2A illustrates visual representation 200 of multi-phased scheduling, in accordance with at least one embodiment. In at least one embodiment, a multi-phased scheduling process exemplified by visual representation 200 can be performed by the system in FIG. 1 (e.g., multi-phased scheduler system 100) to receive data operations, identify phases of the data operations, and optimally schedule the phases.

In at least one embodiment, data operation A 202 indicates a single window reservation. In at least one embodiment, a single window reservation of timeframe t₁-t₄ restricts any other operation from also occurring within timeframe t₁-t₄ (restriction indicated by the gray background of data operation A 202). In at least one embodiment, data operation A 202 comprises three separate phases: phase 1 204 occurring between t₁ and t₂, phase 2 206 occurring between t₂ and t₃, and phase 3 208 occurring between t₃ and t₄. In at least one embodiment, phase 2 206 is the only phase where other operations need to be restricted (as indicated by a gray background), thus enabling overlap or shifting of phases to better optimize the available schedule.

FIG. 2B illustrates visual representation 210 of multi-phased scheduling, in accordance with at least one embodiment. In at least one embodiment, a multi-phased scheduling process exemplified by visual representation 210 can be performed by the system in FIG. 1 (e.g., multi-phased scheduler system 100) to receive data operations, identify phases of the data operations, and optimally schedule the phases.

In at least one embodiment, phase 1 212, phase 2 214, and phase 3 216 of data operation A are shifted to accommodate a conflict period 218. In at least one embodiment, conflict period 218 is a blackout period, a restriction period (e.g., a holiday), or another period in which a phase cannot be performed. In at least one embodiment, because data operation A is divided into phases, data operation A can be partially completed around conflict period 218, instead of entirely before or after conflict period 218, and thus optimizing the scheduling capability of the scheduling framework.

In an embodiment, a multi-phased scheduling process exemplified by visual representations 200 and 210 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of processes exemplified by visual representations 200 and 210 may be performed by any suitable system, such as the computing device 1100 of FIG. 11.

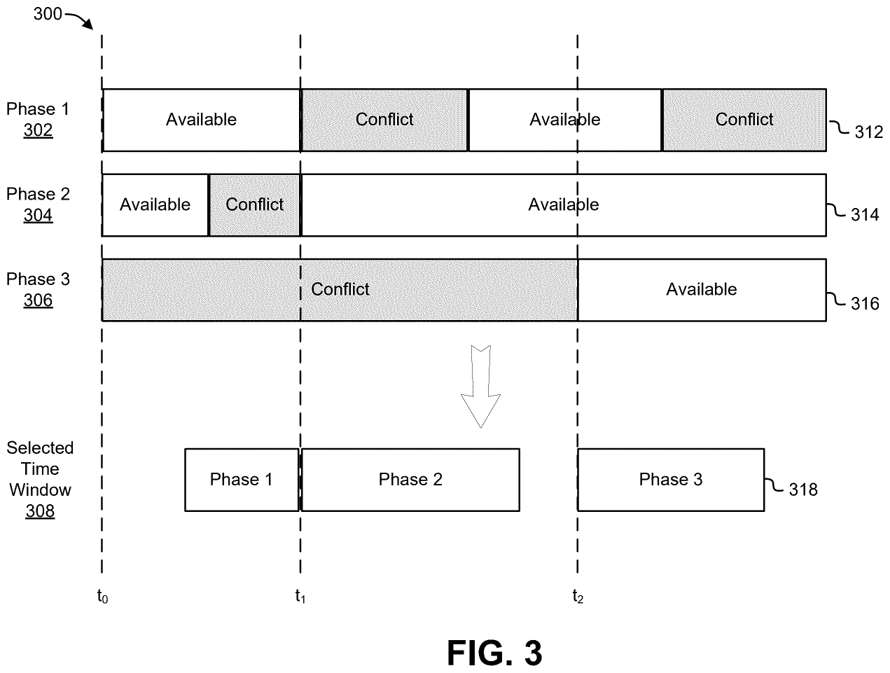

FIG. 3 illustrates a visual representation 300 of multi-phased scheduling, in accordance with at least one embodiment. In at least one embodiment, a multi-phased scheduling process exemplified by visual representation 300 can be performed by a system, such as the system described in FIG. 1 (e.g., multi-phased scheduler system 100) to receive data operations, identify phases of the data operations, and optimally schedule the phases.

In at least one embodiment, a data operation comprises multiple phases. In at least one embodiment, a data operation has three phases: phase 1 302, phase 2 304, phase 3 306. (e.g., a preparation phase, a cutover phase, and a post cutover phase.) In at least one embodiment, each of the phases have a potential time window in which the phase can be scheduled. Phase 1 window 312, phase 2 window 314, and phase 3 window 316 show which time windows are available and which time windows are blocked due to a conflict for each respective phase. In at least one embodiment, the multi-phased scheduler system would identify and select an optimal time window for each of the respective phases.

In this example, phase 1 has 2 available periods and 2 conflict periods during this time range; phase 2 has 2 available periods and 1 conflict period during this time range; and phase 3 has 1 available period and 1 conflict period during the time range. In this example, given these conflict periods, the multi-phased schedule system would schedule phase 1 during an availability period between to and t₁, phase 2 would be scheduled during an availability period after t₁ and t₂, and phase 3 would be scheduled during an availability period after t₂. The phases would then be additionally optimized to minimize downtime between phases, such that phase 1 ends at t₁ where phase 2 begins and phase 3 would begin as soon its conflict period ends at t₂.

In an embodiment, a multi-phased scheduling process exemplified by visual representations 300 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of processes a multi-phased scheduling process exemplified by visual representation 300 may be performed by any suitable system, such as the computing device 1100 of FIG. 11.

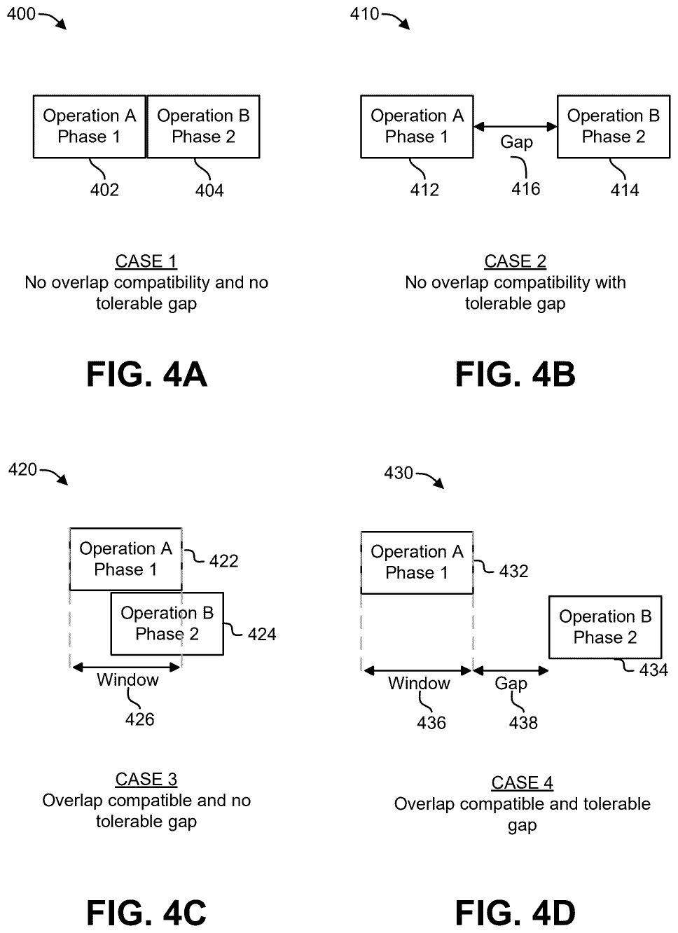

FIGS. 4A-4D illustrate visual representations 400, 410, 420, and 430 of relationships between phases of a data operation, in accordance with at least one embodiment. In at least one embodiment, a multi-phased scheduling process exemplified by visual representations 400, 410, 420, and 430 can be performed a system, such as the system described in FIG. 1 (e.g., multi-phased scheduler system 100) to optimally schedule one or more phases based on the relationship and/or conflict between the one or more phases. In at least one embodiment, visual representations 400, 410, 420, and 430 illustrate a relationship indicating whether one or phases is capable of overlap with one another or whether a tolerable time gap can exist (e.g., an acceptable or predefined time period or time range between execution of the one or more phases).

FIG. 4A illustrates a visual representation 400 of a first case relationship between phase 1 of operation A 402 and phase 2 of operation B 404. In this example, phase 1 402 and phase 2 404 cannot be performed at the same time (no overlap compatibility between phases), but phase 2 404 must occur immediately after phase 1 402 (no tolerable time gap between phases). In this example, when the multi-phased scheduler system (e.g., system 100 or server 104) proposes a time window or time range for phase 1 402 and phase 2 404, this first case relationship is considered in order to find an optimal timeframe where phase 1 402 and phase 2 404 can immediately be performed in sequence.

FIG. 4B illustrates a visual representation 410 of a second case relationship between phase 1 of operation A 412 and phase 2 of operation B 414. In this example, phase 1 412 and phase 2 414 cannot be performed at the same time (no overlap capability between phases), but phase 2 414 can be scheduled to be performed at any time within a given time range gap 416 after phase 1 412 (a tolerable time gap allowed between phases). In this example, when the multi-phased scheduler system (e.g., system 100 or server 104) proposes a time window or time range for phase 1 412 and phase 2 414, this second case relationship is considered in order to find an optimal timeframe where phase 1 412 is performed and phase 2 414 is performed after a given amount of time that best fits the schedule.

FIG. 4C illustrates a visual representation 420 of a third case relationship between phase 1 of operation A 422 and phase 2 of operation B 424. In this example, phase 1 422 and phase 2 424 can be performed at the same time (phase compatible, overlap between phases allowed), but a start of phase 2 424 must be scheduled within window 426 such that phase 2 424 is performed either concurrently with or immediately after phase 1 412 (no tolerable time gap allowed between a start of the phases). In this example, when the multi-phased scheduler system (e.g., system 100 or server 104) proposes a time window or time range for phase 1 422 and phase 2 424, this third case relationship is considered in order to find an optimal timeframe where phase 1 422 and phase 2 424 is performed either concurrently or immediately after one another in a manner that best fits the schedule.

FIG. 4D illustrates a visual representation 430 of a fourth case relationship between phase 1 of operation A 432 and phase 2 of operation B 434. In this example, phase 2 434 can be performed either at a concurrent time with phase 1 432 (phases compatible, overlap between phases allowed) or at any time within a given time gap 438 after phase 1 432 (a tolerable time gap allowed between phases). In this example, which provides the greatest flexibility in scheduling data operations, the multi-phased scheduler system (e.g., system 100 or server 104) proposes a time window with this fourth case relationship considered in order to find an optimal timeframe where phase 1 432 and phase 2 434 can be performed at a timing that best fits the schedule.

In an embodiment, a multi-phased scheduling process exemplified by visual representations 400, 410, 420, and 430 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of processes exemplified by visual representations 400, 410, 420, and 430 may be performed by any suitable system, such as the computing device 1100 of FIG. 11.

FIG. 5 illustrates a visual representation 500 of a proposal function used with a multi-phased scheduler system, in accordance with at least one embodiment. In at least one embodiment, a multi-phased scheduling process exemplified by visual representation 500 can be performed by a system, such as the system described in FIG. 1 (e.g., multi-phased scheduler system 100) to optimally schedule one or more phases based on the relationship and/or conflict between the one or more phases. In at least one embodiment, a multi-phased scheduling process exemplified by visual representation 500 is caused by a propose API performed by a propose module of a processor (e.g., propose module 108 of processor 106).

In at least one embodiment, a propose API performed by a propose module of a processor identifies possible timeframe or time windows in which a given data operations can be scheduled. In at least one embodiment, when a propose API is called, a possible time window or time range for each phase is gathered, followed by a determination of a relationship between phases (as described with reference to FIGS. 4A-4D). In this example, a propose module has identified a possible time window 502 in which phase 1 of operation A 506 and a possible time window 504 in which phase 2 of operation B 508 can be scheduled. In at least one embodiment, a propose module identifies conflicts that are associated with phase 1 506 and phase 2 508 in order to determine where within in the window the phases should be scheduled. For example, if phase 1 and phase 2 must be performed consecutively with no overlap (e.g., the first case of FIG. 4A), then propose module might identify that phase 1 506 should take place at the end of the time window 502 and phase 2 508 should be placed within time window 504 at a time immediately following phase 1 506.

In an embodiment, a propose API of a multi-phased scheduling process exemplified by visual representation 500 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of processes exemplified by visual representation 500 may be performed by any suitable system, such as the computing device 1100 of FIG. 11.

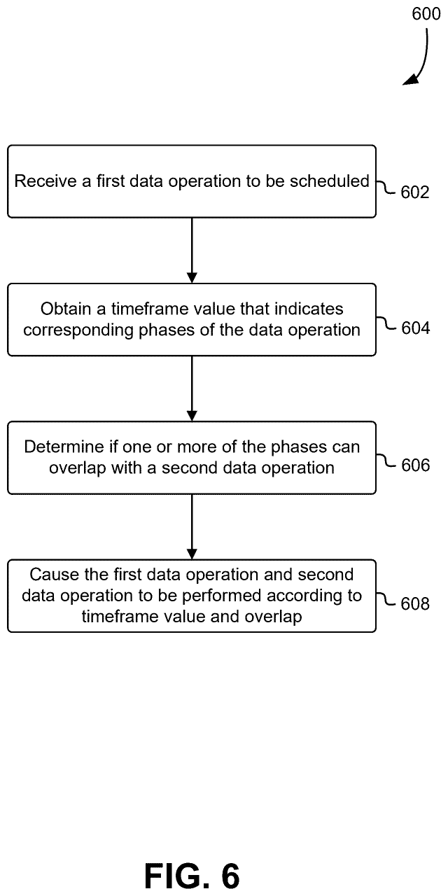

FIG. 6 illustrates a multi-phased scheduling process 600, in accordance with at least one embodiment. In at least one embodiment, a system such as the system described in FIG. 1 (e.g., multi-phased scheduler system 100 of FIG. 1) performs process 600 to determine a timeframe for one or more data operations and schedule the one or more operations based, at least in part, on capability of overlap between the one or more data operations. In at least one embodiment, process 600 splits the data operation into phases, determines which phases can be concurrently performed with a phase of a different operation, and schedules the operations based on both the timeframe and the determined concurrency

In at least one embodiment, at step 602, a system receives a first data operation (e.g., the data operation 102 of FIG. 2) to be scheduled. In at least one embodiment, a first data operation is one a plurality of data operations that perform a function corresponding to a receiving servers (e.g., data center servers 120). In at least one embodiment, a first data operation is one of data cloning, move, monthly server patching, DBDrain, rack drain, app server drain, Delete F5 VIP, F5 To ADCv2 Migration, Manual Change, AIS Node Drain, AIS In-Place Upsize, IAElasticNodeDrain, KEK Rotation-TSE, AIS Partition Drain, AutomationAsAService, IAStandaloneElasticNodeDrain, Read Replica Provision, and/or another type of automation preset by a user.

In at least one embodiment, at step 604, the system obtains a timeframe value that indicates corresponding phases of the first data operation. In at least one embodiment, after the system receives a first data operation, a processor of the system identifies the first data operation and what phases, if any, comprise the first data operation (e.g., through propose module 108 or schedule module 110). In at least one embodiment, the system performs a propose API to identify a possible time window in which the first data operation or the phases of the first data operation can be performed (e.g., as shown in FIG. 5).

In at least one embodiment, at step 606, the system determines whether one or more of the phases of the first data operation is capable of being performed concurrently (at an overlap) with one or more phases of a second data operation. In at least one embodiment, after the system has identified the phases of a first data operation and a possible time window for the phases, the system further obtains the time windows for one or more second data operations already scheduled (e.g., as stored in schedule 116). In at least one embodiment, a processing module of the system (e.g., through propose module 108 or schedule module 110) identifies whether one or more phases of the first operation is capable of being performed concurrently with one or more phases of one or more second data operations. In at least one embodiment, the system performs a schedule API to set and establish a time window or a time range in which the first data operation or the phases of the first data operation can be performed relative to the one or more phases of the one or more second data operations (e.g., as shown in FIGS. 3 and 5).

In at least one embodiment, at step 608, the system causes the one or more first data operations and the one or more second data operations to be performed based, at least in part, on the schedule established from steps 604 and 606 according to a timeframe and an overlap. In at least one embodiment, one or more processors of the system perform the one or more first and second data operations at one or more targets devices (e.g., data center servers 120).

In at least one embodiment, performing process 600 of FIG. 6, multiple data operations can be achieved during the same reserved time window. In at least one embodiment, performing process 600 enables a company to service many more clients and their data operations or automations concurrently.

In an embodiment, some or all of process 600 (or any other processes described such as with reference to FIGS. 2-5, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 600 may be performed by any suitable system, such as the computing device 1100 of FIG. 11.

FIG. 7 illustrates a proposal process 700 used with a multi-phased scheduling system, in accordance with at least one embodiment. In at least one embodiment, a system such as the system described in FIG. 1 (e.g., multi-phased scheduler system 100 of FIG. 1) performs process 700 to determine a timeframe for one or more data operations to be performed and proposes a time range or a single window in which the data operations can be optimally performed relative to other data operations. In at least one embodiment, process 600 splits the data operation into phases, determines which phases can be concurrently performed with a phase of a different operation, and schedules the operations based on both the timeframe and the determined concurrency.

In at least one embodiment, proposal process 700 is performed by calling a propose API (e.g., using propose module 108 of processor 106) to identify possible time windows in which one or more phases of one or more operations can be performed (e.g., as shown with reference to FIG. 5).

In at least one embodiment, at step 702, a system (e.g., server 104 or processor 106) receives a data operation to be scheduled and performed. In at least one embodiment, data operations include data cloning, move, monthly server patching, DBDrain, rack drain, app server drain, Delete F5 VIP, F5 To ADCv2 Migration, Manual Change, AIS Node Drain, AIS In-Place Upsize, IAElasticNodeDrain, KEK Rotation-TSE, AIS Partition Drain, AutomationAsAService, IAStandaloneElasticNodeDrain, Read Replica Provision, and/or other types of automations preset by a user. In at least one embodiment, the data operation received is a regularly scheduled operation that is applied to make a change to a target device (e.g., a server of data center servers 120).

In at least one embodiment, at step 704, the system identifies a profile of the data operation received at step 702. In at least one embodiment, this profile includes information about which conflicts are relevant to the data operation or phase being scheduled. In at least one embodiment, this profile identification includes identifying or determining the one or more phases or sub-operations that comprise the entire data operation, and identifying or determining a related configuration of the data operation (e.g., hardware and software resources needed for access relative to the received data operation). In at least one embodiment, these hardware or software resources include servers, datacenter pods, network resources, load balancers, tomcat services, database instances, or other company specific resources and instances.

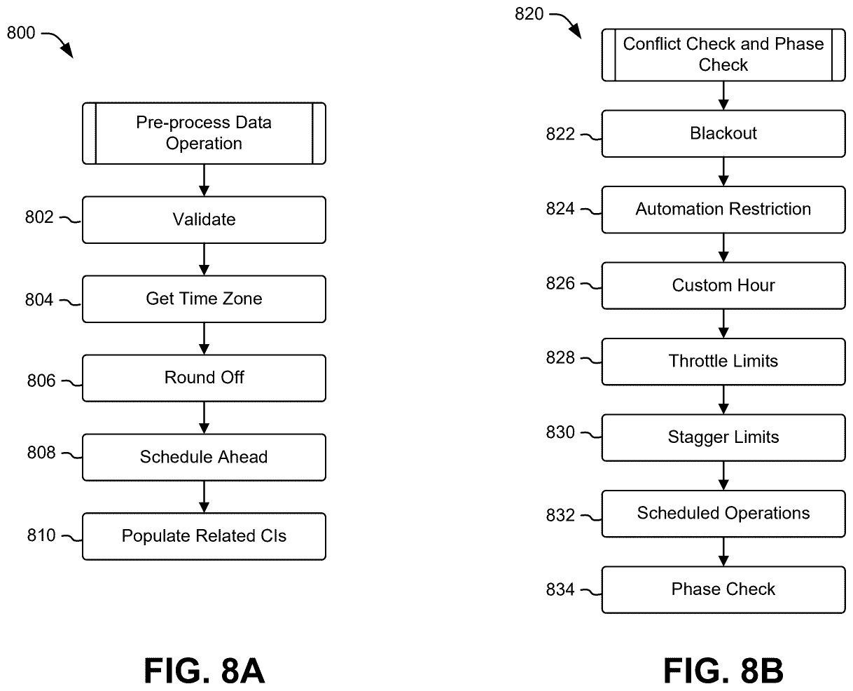

In at least one embodiment, at step 706, the system performs a pre-processing of the data operation received at step 702, in order to prepare the search for a possible time window (described later with reference to FIG. 8A). In at least one embodiment, at step 708, the system then receives all phases related to the input data operation and performs a conflict check for each of the phases relative to other phases in the schedule (further described later with reference to FIG. 8B). In at least one embodiment, conflict checks for each phase is performed in parallel and no phases are scheduled until after all conflict checks are complete.

In at least one embodiment, the system attempts to identify one or more arrangements for each phase that satisfies all conflict requirements. In at least one embodiment, when an arrangement exists that satisfies the conflict requirements, one or more proposed time windows is identified and output as part of a phase check of step 708 (further described with reference to FIG. 8B). In at least one embodiment, at step 710, the system determines whether a time window was identified at step 708 (e.g., whether an arrangement of the phases that satisfies the conflict requirements exists). In at least one embodiment, if no time windows could be found, then the system outputs a failure message to a user or to the another system at step 714.

In at least one embodiment, if the time window could be found at step 710, then the system determines whether the possible time window is either a single timeframe window or a time range at step 712. In at least one embodiment, if the possible time window is a single timeframe window, then the propose API outputs that proposed timeframe at step 716 (for example, to the schedule API) indicating the single reserved timeframe. In at least one embodiment, this single reserved timeframe prevents any other operations from being performed concurrently during the duration of the reservation.

In at least one embodiment, if the system determines that the possible time window is a time range (e.g., multiple possible windows exist that satisfies all conflict requirements), then the propose API outputs at step 718 the time range (for example, to the schedule API) indicating the various possible timeframes that could be used.

In an embodiment, some or all of process 700 (or any other processes described such as with reference to FIGS. 2-6, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 700 may be performed by any suitable system, such as the computing device 1100 of FIG. 11.

FIG. 8A illustrates the pre-processing operation 800 to be used in a multi-phased scheduler system. In at least one embodiment, a system such as the system described in FIG. 1 (e.g., multi-phased scheduler system 100 of FIG. 1) performs process 800 as the pre-process data operation step of a proposal process of a multi-phased scheduler system (e.g., step 706 of FIG. 7).

In at least one embodiment, at step 802, the system validates the profile, identified phases, and configuration (e.g., from step 704 of FIG. 7) of a received data operation and confirms whether all necessary information for the proposal process has been obtained. In at least one embodiment, validation also ensure that a start time cannot occur in the past and identifies whether any conflicts themselves have a conflict that would affect the logic of the conflict check.

In at least one embodiment, at step 804, the system identifies a client-specific or user-specific time zone for the data operation. In at least one embodiment, the system converts the time zone obtained to a server-specific time zone in order to more easily compare different data operations for scheduling. For example, while a client has scheduled a data clone operation in U.S. Eastern Time (ET), the multi-phased scheduler system would convert this time zone to Coordinated Universal Time (UTC) for easier scheduling.

In at least one embodiment, at step 806, the system then rounds off the expected time request of the received data operation to a correspond certain time interval (e.g., 15-minute intervals) and to be stored according to the rounded time interval. For example, if a proposed data operation or a phase of a data operation is originally requested at 13:57, then the system would round the time up to 14:00, so that the operation or phase can be always be scheduled in predetermined intervals in the calendar schedule.

In at least one embodiment, at step 808, the system then checks for whether a “schedule ahead” notification is to be provided to a customer or client that a requested a specific data operation. For example, if a customer has requested a “schedule ahead” of at least 14 days, then the system must send an automated notice to that customer at least 14 days before a data operation will take place. Therefore, in at least one embodiment, the propose API would not schedule a data operation at a time when this notification could not take place.

In at least one embodiment, at step 810, the system then retrieves and populates other related configuration items (CIs) related to the data operation and the client requesting the data operation. For example, if the received data operation is a move operation of Client A, then the system at this step would obtain additional information about the controlled hardware or software related to moving Client A data. This controlled hardware or software, for example, includes server hardware to be transmit the data, server hardware to receive the data, router or switch connections that would handle the transmission, a virtual machine coordinating the data move, or other hardware and software components needed to perform the data operation.

In at least one embodiment, after the pre-processing operation 800 is complete, the data operation and any correlated information obtained during pre-processing is output to a conflict and phase check process (e.g., step 708 of FIG. 7) in order to identify possible time windows for the phases of the received data operation.

FIG. 8B illustrates a conflict and phase check process 820 to be used in a multi-phased scheduler system. In at least one embodiment, a system such as the system described in FIG. 1 (e.g., multi-phased scheduler system 100 of FIG. 1) performs process 820 to as the conflict check and phase check operation step of a proposal process of a multi-phased scheduler system (e.g., step 708 of FIG. 7).

In at least one embodiment, by performing process 820, the system identifies a possible time window in which all phases of the data operation can be performed. In at least one embodiment, process 820 is performed in parallel and timeframe results are shared among the phases of the data operation in order to reduce the time needed to perform multi-phased scheduling and in order to prevent a situation where a proposed phase would need to be reevaluated to accommodate for a later processed phase of the same one or more data operations.

In at least one embodiment, process 820 performs various conflict checks of one or more phases of one or more data operations. In at least one embodiment, conflict checks identify preset constraints identifying when an operation cannot occur either alone or in conjunction with another operation. In at least one embodiment, the proposed time windows or the proposed time range for a data operation is based, at least in part, on these conflict checks. In at least one embodiment, the conflicts include client-specific requires or internal company operational requirements.

In at least one embodiment, at step 822, a blackout period (e.g., times when physical network connections at the data center is shut down) is checked to identify specific windows in which no operations can occur. In at least one embodiment, any identified blackout period is removed as a possible time window for the one or more phases of the data operations.

In at least one embodiment, at step 824, any automation restriction periods (e.g., predefined times when no operations are to be performed such as holidays) are checked to identify specific windows in which no operations should occur. In at least one embodiment, any identified automation restriction period is removed as a possible time window for the one or more phases of the data operation.

In at least one embodiment, at step 826, custom hour restriction periods are checked to identify predetermined time windows (for example, as specified by a client) related to data operations. In at least one embodiment, the custom hour restriction period identifies when no data operations are to be performed. In at least one embodiment, the custom hour restriction period identifies only the time period in which data operations is allowed to be performed. In at least one embodiment, any periods that do not conform to the custom hour restriction is removed as a possible time window for the one or more phases of the data operation.

In at least one embodiment, at step 828, throttle limits of a given time are checked to identify whether performing a phase at the given time would exceed the allowable number of concurrent data operations. In at least one embodiment, a throttle limit restricts the total number of data operations or phases of data operations at a given time in order to prevent system overload or instability. In at least one embodiment, any periods where a throttle limit would be exceeded is removed as a possible time window for the one or more phases of the data operation.

In at least one embodiment, at step 830, stagger limits of a given time are checked to identify whether a delay needs to be established so as to not overwhelm the system at the same time. In at least one embodiment, a stagger limit is a restriction that prevents too many operations from occurring at the same moment and intentionally introduces a nominal delay before the start of a phase. In at least one embodiment, while the throttle limit restricts the total number of data operations for a given data operation window (e.g., only 10 operations allowed concurrently), the stagger limit restricts the start timing within the given time interval (e.g., operations 3 and 4 start one minute after operations 1 and 2.) In at least one embodiment, any periods in which a stagger limit is exceeded (for example, in a case where staggering a given phase would exceed the time window) would be removed as a possible time window for the one or more phases of the data operation.

In at least one embodiment, at step 832, any existing scheduled operations are checked to identify which operations cannot overlap with the currently evaluated phases of the data operation. In at least one embodiment, if an operation already scheduled has a phase that is not compatible for overlap with the current phase (e.g., as shown in FIGS. 4A and 4B), any periods for the previous phases are removed as a possible time for the currently evaluated one or more phases of the data operation.

In at least one embodiment, at step 834, all phases currently being evaluated in parallel are checked against each other in order to find an arrangement of the phases that satisfies the conflict requirements to identify a possible time window for the data operation. In at least one embodiment, this arrangement finds an available time period among the time periods that were not removed at steps 822-832 where each of the phases can be performed in order. In at least one embodiment, after step 834, proposal process 700 would continue at step 710.

In an embodiment, some or all of processes 800 or 820 (or any other processes described such as with reference to FIGS. 2-7, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of processes 800 or 820 may be performed by any suitable system, such as the computing device 1100 of FIG. 11.

FIG. 9 illustrates a scheduling process 900 used with a multi-phased scheduling system, in accordance with at least one embodiment. In at least one embodiment, a system such as the system described in FIG. 1 (e.g., multi-phased scheduler system 100 of FIG. 1) performs process 900 to schedule one or more data operations to be performed at a determined time frame relative to other data operations. In at least one embodiment, process 900 identifies which phases can be concurrently performed with a phase of a different operation and schedules the operations based on both the timeframe and the determined concurrency.

In at least one embodiment, scheduling process 900 is performed by calling a schedule API (e.g., using schedule module 110 of processor 106) to schedule one or more phases of one or more operations to be performed (e.g., as shown with reference to FIG. 5) and storing that schedule into memory (e.g., schedule 116).

In at least one embodiment, at step 902, a system (e.g., server 104 or processor 106) receives a data operation to be scheduled and performed. In at least one embodiment, data operations include data cloning, move, monthly server patching, DBDrain, rack drain, app server drain, Delete F5 VIP, F5 To ADCv2 Migration, Manual Change, AIS Node Drain, AIS In-Place Upsize, IAElasticNodeDrain, KEK Rotation-TSE, AIS Partition Drain, AutomationAsAService, IAStandaloneElasticNodeDrain, Read Replica Provision, and/or other types of automations preset by a user. In at least one embodiment, the data operation received is a regularly scheduled operation that is applied to make a change to a target device (e.g., a server of data center servers 120).

In at least one embodiment, at step 904, the system identifies a profile of the data operation received at step 902. In at least one embodiment, this profile identification includes identifying or determining the one or more phases or sub-operations that comprise the entire data operation, and identifying or determining a related configuration of the data operation (e.g., hardware and software resources needed for access relative to the received data operation).

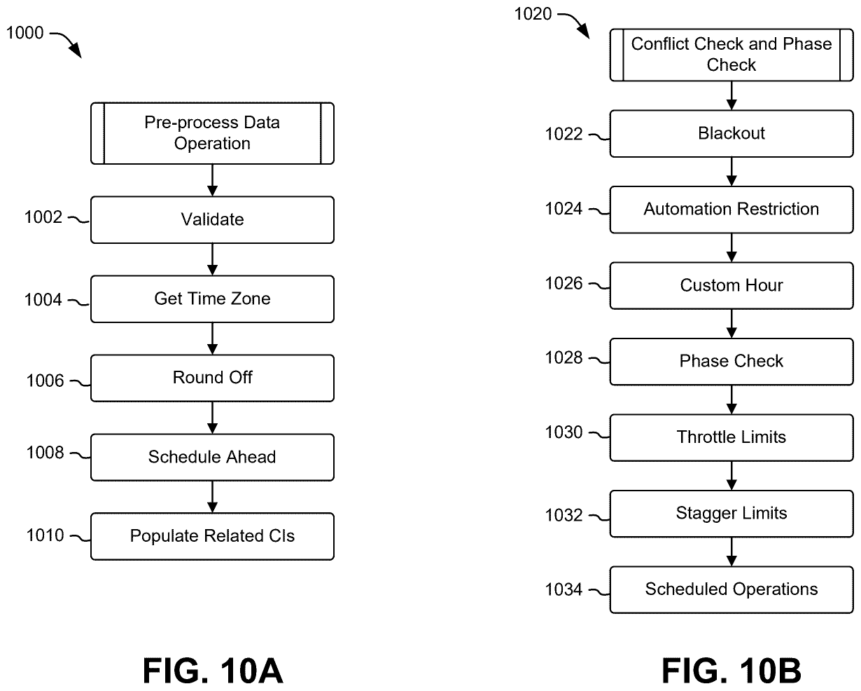

In at least one embodiment, at step 906, the system performs a pre-processing of the data operation received at step 902, in order to prepare scheduling an operation within a predetermined time window (described later with reference to FIG. 10A). In at least one embodiment, at step 908, the system then receives all phases related to the input data operation and performs a conflict check for each of the phases relative to other phases in the schedule (further described later with reference to FIG. 10B). In at least one embodiment, conflict checks for each phase is performed in parallel and no phases are scheduled until after all conflict checks are complete.

In at least one embodiment, the system attempts to identify one or more arrangements for each phase that satisfies all conflict requirements. In at least one embodiment, when a proposed time window (e.g., received from propose API) satisfies the conflict requirements, the one or more phases is scheduled and the time is reserved for the operation.

In at least one embodiment, at step 910, the system determines whether the operation was performed or executed at the scheduled time. In at least one embodiment, if the operation could not be performed, then the system outputs a failure message to a user or to the another system at step 914. In at least one embodiment, if operation was able to be performed at the scheduled time, then the system outputs a success message to a user or to another system at step 912.

In an embodiment, some or all of process 900 (or any other processes described such as with reference to FIGS. 2-8, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 900 may be performed by any suitable system, such as the computing device 1100 of FIG. 11.

FIG. 10A illustrates the pre-processing operation 1000 to be used in a multi-phased scheduler system. In at least one embodiment, a system such as the system described in FIG. 1 (e.g., multi-phased scheduler system 100 of FIG. 1) performs process 1000 as the pre-process data operation step of a proposal process of a multi-phased scheduler system (e.g., step 906 of FIG. 9).

In at least one embodiment, at step 1002, the system validates the profile, identified phases, and configuration (e.g., from step 904 of FIG. 9) of a received data operation and confirms whether all necessary information for the proposal process has been obtained. In at least one embodiment, validation also ensure that a start time cannot occur in the past and identifies whether any conflicts themselves have a conflict that would affect the logic of the conflict check.

In at least one embodiment, at step 1004, the system identifies a client-specific or user-specific time zone for the data operation. In at least one embodiment, the system converts the time zone obtained to a server-specific time zone in order to more easily compare different data operations for scheduling. For example, while a client has scheduled a data clone operation in U.S. Eastern Time (ET), the multi-phased scheduler system would convert this time zone to Coordinated Universal Time (UTC) for easier scheduling.

In at least one embodiment, at step 1006, the system then checks the rounded off time to verify that the received data operation is properly set to a certain time interval (e.g., 15-minute intervals) that accommodates the calendar schedule.

In at least one embodiment, at step 1008, the system then checks the schedule ahead notification requirement for a given customer, client, or user to identify how far in the future a notification must be sent, if any. In at least one embodiment, a data operation would be not scheduled until such a point where this schedule ahead requirement can be satisfied. For example, if a schedule ahead is scheduled for 14 days, then the system would not schedule a data operation at 12 days in the future because the notification could not take place at the prescribed time.

In at least one embodiment, at step 1010, the system then retrieves and populates other related configuration items (CIs) related to the data operation and the client requesting the data operation. For example, if the received data operation is a move operation of Client A, then the system at this step would obtain additional information about the controlled hardware or software related to moving Client A data. This controlled hardware or software, for example, includes server hardware to be transmit the data, server hardware to receive the data, router or switch connections that would handle the transmission, a virtual machine coordinating the data move, or other hardware and software components needed to perform the data operation.

In at least one embodiment, after the pre-processing operation 1000 is complete, the data operation and any correlated information obtained during pre-processing is output to a conflict and phase check process (e.g., step 908 of FIG. 9) in order to schedule the phases of the data operation into the proposed time window.

FIG. 10B illustrates a conflict and phase check process 1020 to be used in a multi-phased scheduler system. In at least one embodiment, a system such as the system described in FIG. 1 (e.g., multi-phased scheduler system 100 of FIG. 1) performs process 1020 to as the conflict check and phase check operation step of a proposal process of a multi-phased scheduler system (e.g., step 908 of FIG. 9).

In at least one embodiment, by performing process 1020, the system schedules a data operation to be performed at a time window in which all phases of the data operation can be performed. In at least one embodiment, the system then executes all data operations based, at least in part, on the schedule.

In at least one embodiment, process 1020 performs various conflict checks of one or more phases of one or more data operations. In at least one embodiment, conflict checks identify preset constraints identifying when an operation cannot occur either alone or in conjunction with another operation. In at least one embodiment, whether a phase of a data operation is scheduled or not is based, at least in part, on these conflict checks. In at least one embodiment, the conflicts include client-specific requires or internal company operational requirements.

In at least one embodiment, at step 1022, the system verifies that the proposed time window in which a phase is to be scheduled does not include any blackout periods in which no operations can occur. In at least one embodiment, at step 1024, the system verifies that the proposed time window in which a phase is to be scheduled does not include any automation restriction periods in which no operations should occur. In at least one embodiment, at step 1026, the system verifies that the proposed time window in which a phase is to be scheduled conforms with any custom hour restrictions provided by a customer or user. In at least one embodiment, at step 1028, any existing scheduled operations are checked to confirm which operations cannot overlap with the currently evaluated phases of the data operation.

In at least one embodiment, after the checks are performed at steps 1022-1028, then the system begins scheduling the operation into memory. In at least one embodiment, the system schedules by setting throttle limits of a given time window at step 1030, stagger limits of a given time window at step 1032, and finally scheduling the operation at step 1034. In at least one embodiment, this scheduling process is established the throttle limits, stagger limits, and scheduling as mutual exclusion (mutex) objects, such that they are locked and cannot be changed by other operations. In at least one embodiment, after step 1034, schedule process 900 would continue at step 910.

In an embodiment, some or all of processes 1000 or 1020 (or any other processes described such as with reference to FIGS. 2-9, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of processes 1000 or 1020 may be performed by any suitable system, such as the computing device 1100 of FIG. 11.

FIG. 11 illustrates a system 1100 in which various embodiments can be implemented. The system 1100 may include a client network 1102 and a provider platform 1104 that are operably connected via a network 1106 (e.g., the Internet). In an embodiment, the client network 1102 may be a private local network 1108, such as a local area network (LAN) that includes a variety of network devices that include, but are not limited to, switches, servers, and routers. In an embodiment, the client network 1102 can comprise an enterprise network that can include one or more LANs, virtual networks, data centers, and/or other remote networks. In an embodiment, the client network 1102 can be operably connected to one or more client devices 1110 such as example client device 1110A, 1110B so that the client devices 1110 are able to communicate with each other and/or with the provider platform 1104. In an embodiment, the client devices 1110 can be computing systems and/or other types of computing devices generally referred to as Internet of Things (IoT) devices that can access cloud computing services, for example, via a web browser application or via an edge device 1112 that may act as a gateway between one or more client devices 1110 and the platform 1104 (e.g., second client device 1110B). In an embodiment, the client network 1102 can include a management, instrumentation, and discovery (MID) server 1114 that facilitates communication of data between the network hosting the platform 1104, other external applications, data sources, and services, and the client network 1102. In an embodiment, the client network 1102 may also include a connecting network device (e.g., a gateway or router) or a combination of devices that implement a customer firewall or intrusion protection system.

In an embodiment, the client network 1102 can be operably coupled to the network 1106, which may include one or more suitable computing networks, such a large area network (LAN), wide area networks (WAN), the Internet, and/or other remote networks, that are operable to transfer data between the client devices 1110 and the provider platform 1104. In an embodiment, one or more computing networks within network 1106 can comprise wired and/or wireless programmable devices that operate in the electrical and/or optical domain. For example, network 1106 may include wireless networks, such as cellular networks (e.g., Global System for Mobile Communications (GSM) based cellular network), WIN networks, and/or other suitable radio-based networks. The network 1106 may also employ any suitable network communication protocols, such as Transmission Control Protocol (TCP), Internet Protocol (IP), and the like. In an embodiment, network 1106 may include a variety of network devices, such as servers, routers, network switches, and/or other suitable network hardware devices configured to transport data over the network 1106.

In an embodiment, the provider platform 1104 may be a remote network (e.g., a cloud network) that is able to communicate with the client devices 1110 via the client network 1102 and network 1106. In an embodiment, the provider platform 1104 can comprise a configuration management database (CMDB) platform. In an embodiment, the provider platform 1104 provides additional computing resources to the client devices 1110 and/or the client network 1102. For example, by utilizing the provider platform 1104, in some examples, users of the client devices 1110 can build and execute applications for various enterprise, IT, and/or other organization-related functions. In one embodiment, the provider platform 1104 can be implemented on the one or more data centers 1116, where each data center 1116 can correspond to a different geographic location in some examples. In an embodiment, one or more the data centers 1116 includes a plurality of servers 1118 (also referred to in some examples as application nodes, virtual servers, application servers, virtual server instances, application instances, application server instances, or the like), where each server 1118 can be implemented on a physical computing system, such as a single electronic computing device (e.g., a single physical hardware server) or across multiple-computing devices (e.g., multiple physical hardware servers). Examples of servers 1118 can include a virtual server, a web server (e.g., a unitary Apache installation), an application server (e.g., a unitary Java Virtual Computer), and/or a database server.

To utilize computing resources within the provider platform 1104, in an embodiment, network operators may choose to configure the data centers 1116 using a variety of computing infrastructures. In an embodiment, one or more of the data centers 1116 can be configured using a multi-instance cloud architecture to provide every customer with its own unique customer instance or instances. For example, a multi-instance cloud architecture of some embodiments can provide each customer instance with its own dedicated application server and dedicated database server. In some examples, the multi-instance cloud architecture could deploy a single physical or virtual server 1118 and/or other combinations of physical and/or virtual servers 1118, such as one or more dedicated web servers, one or more dedicated application servers, and one or more database servers, for each customer instance. In an embodiment of a multi-instance cloud architecture, multiple customer instances can be installed on one or more respective hardware servers, where each customer instance is allocated certain portions of the physical server resources, such as computing memory, storage, and processing power. By doing so, in some examples each customer instance has its own unique software stack that provides the benefit of data isolation, relatively less downtime for customers to access the platform 1104, and customer-driven upgrade schedules.

In some embodiments, the provider platform 1104 includes a computer-generated data management server that receives, via network 1106 and/or an internal network within or across different data centers, computer-generated data for storage and analysis. For example, log entries can be sent from client devices/servers 1110, MID server 1114 (e.g., agent server acting as the intermediary in client network 1102 to facilitate access to client network 1102 by the network hosting the platform 1104), and/or servers in data centers 1116 to a log management server in data centers 1116.

Although FIG. 11 illustrates a specific embodiment of a cloud computing system 1100, the disclosure is not limited to the specific embodiments illustrated in FIG. 11. For instance, although FIG. 11 illustrates that the platform 1104 is implemented using data centers, other embodiments of the platform 1104 are not limited to data centers and can utilize other types of remote network infrastructures. Some embodiments may combine one or more different virtual servers into a single virtual server. The use and discussion of FIG. 11 are only examples to facilitate case of description and explanation and are not intended to limit the disclosure to the specific examples illustrated therein. In an embodiment, the respective architectures and frameworks discussed with respect to FIG. 11 can incorporate suitable computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as JavaR, C, C# or C++, or any scripting language, such as Ruby, PHP, Perl, Python or TCL, as well as combinations thereof. In an embodiment, the one or more servers also include database servers, including without limitation those commercially available from Oracle, MicrosoftR, SybaseR, and IBMR as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

One aspect of the disclosure includes a method for obtaining a timeframe value that indicates a corresponding phase of a first data operation. The method may further include determining, based on the timeframe value, an overlap between the corresponding phase of the first data operation and a phase of a second data operation. The method may further include causing the first and second data operations to be performed according to the timeframe value and the overlap.

Implementations of the disclosure may include one or more of the following features. The method may include scheduling the corresponding phase of the first data operation and the phase of the second data operation to be performed within a predetermined window. The method may additionally indicate that determining the overlap is based, at least in part, on identifying a relationship indicating the overlap and a time gap between the corresponding phase of the first data operation and the phase of the second data operation. The method may further include identifying a conflict associated with the corresponding phase of the first data operation, wherein determining the overlap is based, at least in part, on the conflict identified. The method may further include performing an application programming interface (API) to identify the timeframe value in which the first and second data operations are to be performed and proposing the timeframe value identified to another API. The method may further include determining, based on the timeline value, a gap between a third data operation phase and one of the corresponding phase of the first data operation or the phase of the second data operation and performing, as a result of the determination, the third data operation phase at a timing according to the gap. The method may further include performing an application programming interface (API) to remove one or more secondary phases from a schedule and scheduling the first and second data operations to be performed according to the timeframe value, the overlap, and a removal of the one or more secondary phases.

Another aspect of the disclosure includes a system comprises one or more processors and a memory including computer-executable instructions. The one or more processors, when executing the computer-executable instructions, may cause the system to obtain a timeframe value that indicates a corresponding phase of a first data operation. The one or more processors may further cause the system to determine, based on the timeframe value, an overlap between the corresponding phase of the first data operation and a phase of a second data operation. The one or more processors may further cause the system to cause the first and second data operations to be performed according to the timeframe value and the overlap.

Implementations of the disclosure may additionally include one or more of the following features. The one or more processors may further cause the system to schedule the corresponding phase of the first data operation and the phase of the second data operation to be performed within a predetermined window. The one or more processors may further cause the system to indicate that the overlap is determined based on a relationship between the corresponding phase of the first data operation and the phase of the second data operation. The one or more processors may further cause the system to determine the overlap based, at least in part, on identifying a conflict associated with the corresponding phase of the first data operation. The one or more processors may further cause the system to indicate the conflict is at least one of a blackout period, an automation restriction, a custom hour requirement, a throttle limit, or a stagger limit. The one or more processors may further cause the system to determine a gap timing between a third data operation phase and one of the at least one of the corresponding phase of the first data operation and the phase of the second data operation and cause the third data operation phase to be performed at a timing based, at least in part, on the determined gap. The one or more processors may further cause the system to indicate that a schedule indicating the timeframe value is stored in the memory.

Another aspect of the disclosure includes a non-transitory computer-readable storage medium having stored thereon executable instructions that are executable by one or more processors of a computer system. The computer-readable storage medium may include instructions that cause the computer system to obtain a timeframe value that indicates a corresponding phase of a first data operation. The computer-readable storage medium may further include instructions that cause the computer system to determine, based on the timeframe value, an overlap between the corresponding phase of the first data operation and a phase of a second data operation. The computer-readable storage medium may further include instructions that cause the computer system to cause the first and second data operations to be performed according to the timeframe value and the overlap.

Implementations of the disclosure may additionally include one or more of the following features. The computer-readable storage medium may further include instructions that cause the computer system to schedule the corresponding phase of the first data operation and the phase of the second data operation to be performed within a predetermined window. The computer-readable storage medium may further include instructions that cause the computer system to identify an overlap compatibility of one or more phases of the first data operation and one or more phases of the second data operation. The computer-readable storage medium may further include instructions that cause the computer system to identify a conflict associated with the corresponding phase of the first data operation. The computer-readable storage medium may further include instructions that cause the computer system to perform an application programming interface (API) to schedule a time window for the first and second data operations to be performed based, at least in part, on the determined overlap and store the scheduled time window into memory. The computer-readable storage medium may further include instructions that cause the computer system to determine a gap timing between a third data operation phase and one of the at least one of the corresponding phase of the first data operation and the phase of the second data operation and cause the third data operation phase to be performed at a timing based, at least in part, on the determined gap.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—For example, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A method, comprising:
obtaining a timeframe value that indicates a corresponding phase of a first data operation;
determining, based on the timeframe value, an overlap between the corresponding phase of the first data operation and a phase of a second data operation; and
causing the first and second data operations to be performed according to the timeframe value and the overlap.

2. The method of claim 1, further comprising:
scheduling the corresponding phase of the first data operation and the phase of the second data operation to be performed within a predetermined window.

3. The method of claim 1, wherein determining the overlap is based, at least in part, on identifying a relationship indicating the overlap and a time gap between the corresponding phase of the first data operation and the phase of the second data operation.

4. The method of claim 1, further comprising:
identifying a conflict associated with the corresponding phase of the first data operation, wherein determining the overlap is based, at least in part, on the conflict identified.

5. The method of claim 1, further comprising:
performing an application programming interface (API) to identify the timeframe value in which the first and second data operations are to be performed; and
proposing the timeframe value identified to another API.

6. The method of claim 1, further comprising:
determining, based on the timeline value, a gap between a third data operation phase and one of the corresponding phase of the first data operation or the phase of the second data operation; and
performing, as a result of the determination, the third data operation phase at a timing according to the gap.

7. The method of claim 1, further comprising:
performing an application programming interface (API) to remove one or more secondary phases from a schedule; and
scheduling the first and second data operations to be performed according to the timeframe value, the overlap, and a removal of the one or more secondary phases.

8. A system, comprising:
one or more processors; and
memory including computer-executable instructions that, if executed by the one or more processors, cause the system to:
obtain a timeframe value that indicates a corresponding phase of a first data operation;
determine, based on the timeframe value, an overlap between the corresponding phase of the first data operation and a phase of a second data operation; and
cause the first and second data operations to be performed according to the timeframe value and the overlap.

9. The system of claim 8, wherein the one or more processors are further to schedule the corresponding phase of the first data operation and the phase of the second data operation to be performed within a predetermined window.

10. The system of claim 8, wherein the overlap is determined based on a relationship between the corresponding phase of the first data operation and the phase of the second data operation.

11. The system of claim 8, wherein the one or more processors are to determine the overlap based, at least in part, on identifying a conflict associated with the corresponding phase of the first data operation.

12. The system of claim 11, wherein the conflict is at least one of a blackout period, an automation restriction, a custom hour requirement, a throttle limit, or a stagger limit.

13. The system of claim 8, wherein the one or more processors further cause the system to:
determine a gap timing between a third data operation phase and one of the at least one of the corresponding phase of the first data operation and the phase of the second data operation; and
cause the third data operation phase to be performed at a timing based, at least in part, on the determined gap.

14. The system of claim 8, wherein a schedule indicating the timeframe value is stored in the memory.

15. A non-transitory computer-readable storage medium having stored thereon executable instructions which, when executed by one or more processors of a computer system, cause the computer system to:
obtain a timeframe value that indicates a corresponding phase of a first data operation;
determine, based on the timeframe value, an overlap between the corresponding phase of the first data operation and a phase of a second data operation; and
cause the first and second data operations to be performed according to the timeframe value and the overlap.

16. The non-transitory computer-readable storage medium of claim 15, wherein the one or more processors further cause the computer system to schedule the corresponding phase of the first data operation and the phase of the second data operation to be performed within a predetermined window.

17. The non-transitory computer-readable storage medium of claim 15, wherein the one or more processors further cause the computer system to identify an overlap compatibility of one or more phases of the first data operation and one or more phases of the second data operation.

18. The non-transitory computer-readable storage medium of claim 15, wherein the one or more processors further cause the computer system to identify a conflict associated with the corresponding phase of the first data operation.

19. The non-transitory computer-readable storage medium of claim 15, wherein the one or more processors further cause the computer system to:
perform an application programming interface (API) to schedule a time window for the first and second data operations to be performed based, at least in part, on the determined overlap; and
store the scheduled time window into memory.

20. The non-transitory computer-readable storage medium of claim 19, wherein the one or more processors further cause the computer system to:
determine a gap timing between a third data operation phase and one of the at least one of the corresponding phase of the first data operation and the phase of the second data operation; and
cause the third data operation phase to be performed at a timing based, at least in part, on the determined gap.
